(19) United States
(12) Patent Application Publication
(10) Pub. No.: US 2019/0353989 A1
(43) Pub. Date: Nov. 21, 2019

(54) DRIVER ASSIST SYSTEM HAVING BURNISHED CAMERA MOUNT

(71) Applicant: TRW AUTOMOTIVE U.S. LLC, Livonia, MI (US)

(72) Inventor: KARTEEK KESAVAMATHAM, Novi, MI (US)

(21) Appl. No.: 15/983,258

(22) Filed: May 18, 2018

(51) Int. Cl. G03B 17/56; B60R 11/04

(52) U.S. Cl. CPC G03B 17/561; B60R 1/00; B60R 11/04

(57) ABSTRACT

A driver assist system for a vehicle includes a module. A camera assembly is connected inside the module. The camera assembly includes a burnished camera mount and a camera lens connected to the burnished camera mount. The camera lens extending into the camera mount.

### FIELD OF THE INVENTION

The present invention relates to a driver assist system and, in particular, to a burnished camera mount of a driver assist system.

### BACKGROUND TO THE INVENTION

In order to assist a driver in operating a vehicle, it is known to dispose various devices in a module that is attached to the vehicle. The devices in the module can include a rain sensor, a temperature sensor, and/or a camera assembly. The camera assembly can, for example, monitor lane departure, assist in maintaining the vehicle in a road lane, provide lane centering/guidance, control operation of the high and/or low beam headlights, detect vehicle presence, provide forward crash warning, perform sign recognition, and/or apply automatic emergency braking in response to the detection of a pedestrian.

The output of the camera can be connected to main control circuitry that analyzes the camera output. It can be important to maintain the optical focus of the camera in order to ensure proper function of the module. One aspect of maintaining the optical focus of the camera can be ensuring the integrity of the camera mount, which locates the camera in the module. Specifically, it can be desirable to ensure that the mounting section does not corrode. Although it has been suggested that the mounting section be manufactured out of corrosion resistant materials (i.e., plastic) it can be desirable to manufacture the mounting section out of metal in order to assist in camera heat dissipation.

### SUMMARY OF THE INVENTION

According to one aspect of the present invention, a driver assist system for a vehicle includes a module. A camera assembly is connected inside the module. The camera assembly includes a burnished camera mount and a camera lens connected to the burnished camera mount. The camera lens extending into the camera mount.

### BRIEF DESCRIPTION OF THE DRAWINGS

Embodiments of the invention will now be described by way of example only, with reference to the accompanying drawings, in which:

FIG. 1 is a module in which a mounting section according to a first aspect of the present invention can be mounted;

FIG. 2 is a sectional view showing the module of FIG. 1 attached to a vehicle windshield;

FIG. 3 is a perspective view of a camera assembly that that utilizes the mounting section according to the first embodiment of the present invention and can be provided in the module of FIG. 1;

FIG. 4 is an exploded view of the camera assembly of FIG. 3;

FIG. 5 is an exploded view of the camera assembly of FIG. 3 from a different angle;

FIG. 6 is a front view of the mounting section according to the first embodiment of the present invention;

FIG. 7 is a rear view of the mounting section according to the first embodiment of the present invention;

FIG. 8 is a top view of the mounting section according to the first embodiment of the present invention;

FIG. 9 is a bottom view of the mounting section according to the first embodiment of the present invention;

FIG. 10 is a right side view of the mounting section according to the first embodiment of the present invention;

FIG. 11 is a left side view of the mounting section according to the first embodiment of the present invention;

FIG. 12 is a perspective view of a camera assembly that utilizes a mounting section according to a second embodiment of the present invention;

FIG. 13 is an exploded view of the camera assembly of FIG. 12;

FIG. 14 is an exploded view of the camera assembly of FIG. 12 from a different angle;

FIG. 15 is a front view of the mounting section according to the second embodiment of the present invention;

FIG. 16 is a rear view of the mounting section according to the second embodiment of the present invention;

FIG. 17 is a top view of the mounting section according to the second embodiment of the present invention;

FIG. 18 is a bottom view of the mounting section according to the second embodiment of the present invention;

FIG. 19 is a right side view of the mounting section according to the second embodiment of the present invention; and

FIG. 20 is a left side view of the mounting section according to the second embodiment of the present invention.

### DETAILED DESCRIPTION

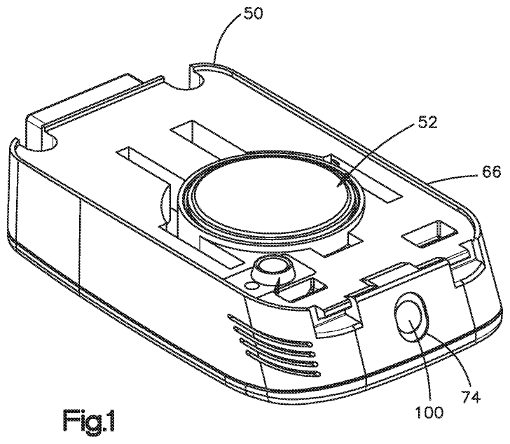

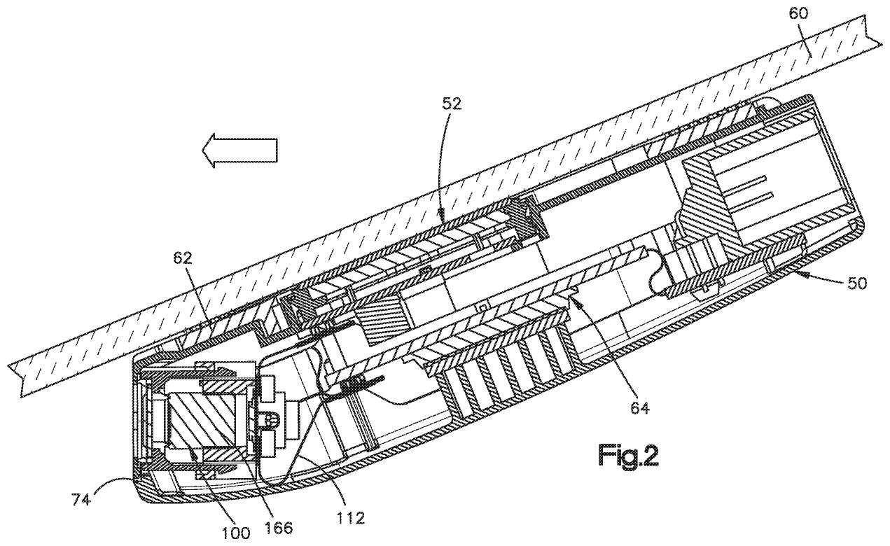

A module 50 (FIGS. 1 and 2) houses one or more devices that can facilitate controlling aspects of vehicle operation. In one example, the module 50 is of the type described in U.S. Patent Application Pub. No. 2012/0013741 A1, the entirety of which is herein incorporated by reference. The module 50 can, for example, house a rain sensor 52, a humidity sensor (not shown), a temperature sensor (not shown), and/or a camera assembly 100. It is contemplated that the module 50 can house any number of devices. The module 50 can be mounted on a windshield 60 of a vehicle via a mounting bracket 62. It is contemplated that the module 50 can be mounted on any other desired portion of a vehicle and/or be mounted using means other than the disclosed mounting bracket 62.

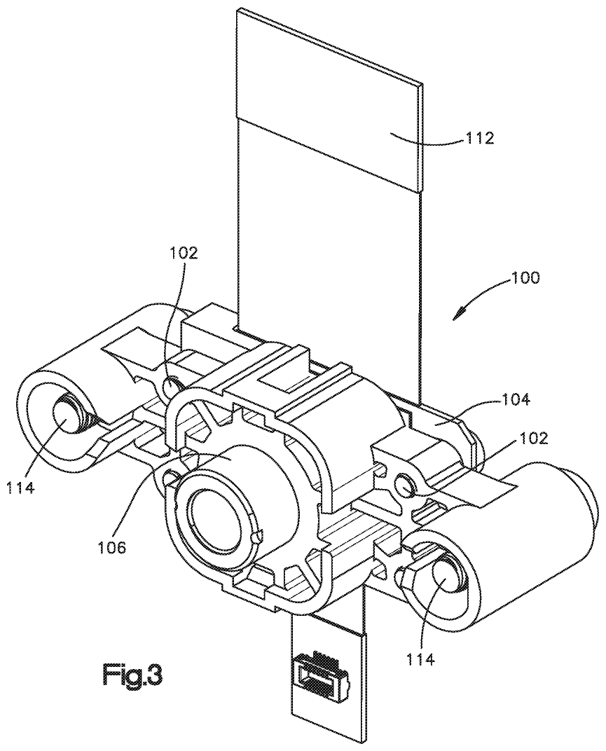

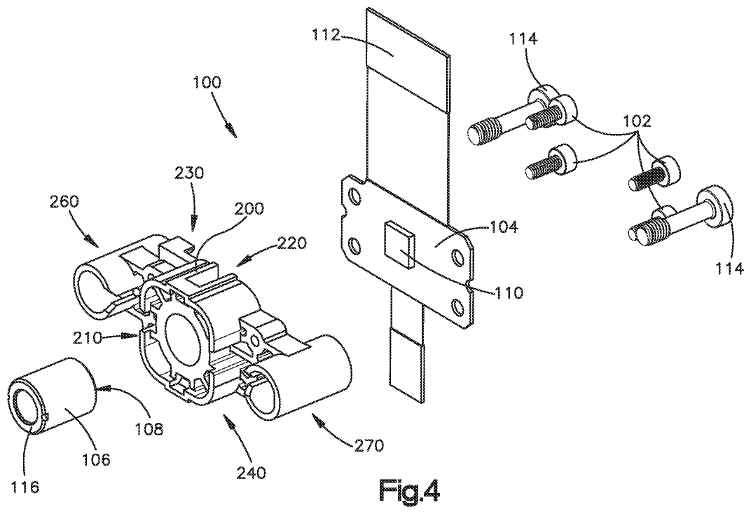

The camera assembly 100 according to one embodiment of the present invention is shown in FIGS. 3-5. First fasteners 102 attach a printed circuit board 104 to a camera mount 200. A camera lens 106 is received in the camera mount 200. A first end portion 108 of the camera lens 106 is disposed adjacent to an image sensor 110 provided on the printed circuit board 104. The image sensor 110 converts an optical image that is transmitted through the camera lens 106 into an electrical signal. A flex connector 112 communicates the electrical signal generated by the image sensor 110 to main control circuitry 64 (FIG. 2) that analyzes the output of the image sensor 110.

Second fasteners 114 anchor the camera assembly 100 in the module 50. When the camera assembly 100 is anchored in the module 50 by the second fasteners 114, a second end portion 116 of the camera lens 106 is disposed in an opening 74 provided on the module 50. The opening 74 provides the camera assembly 100 with a field of view outside of the module 50.

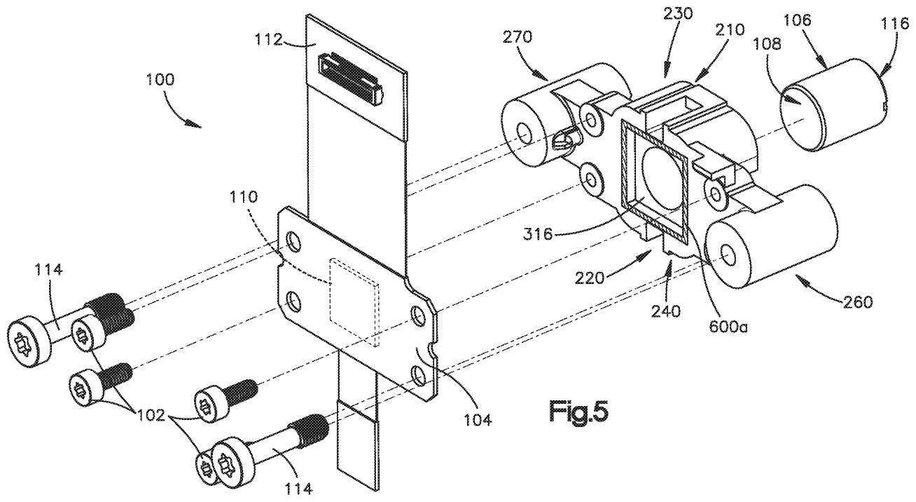

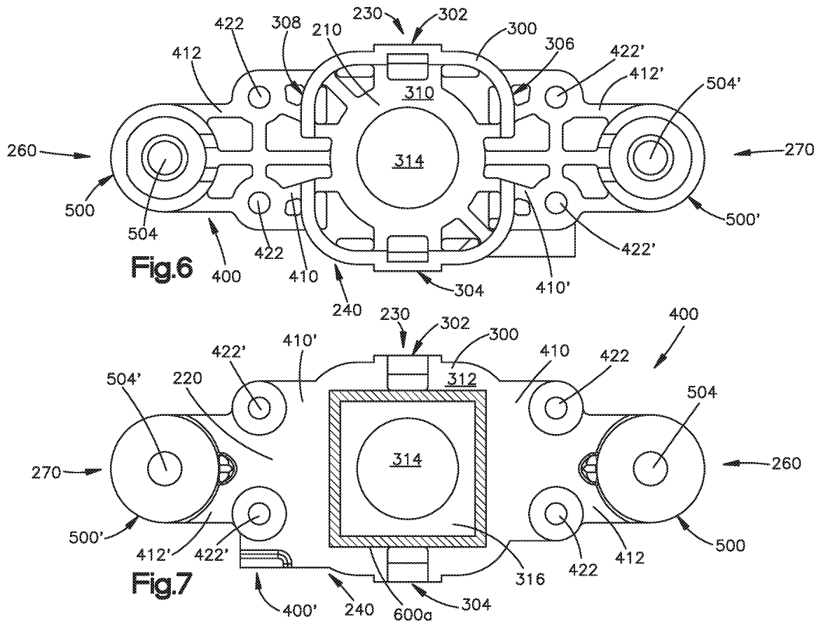

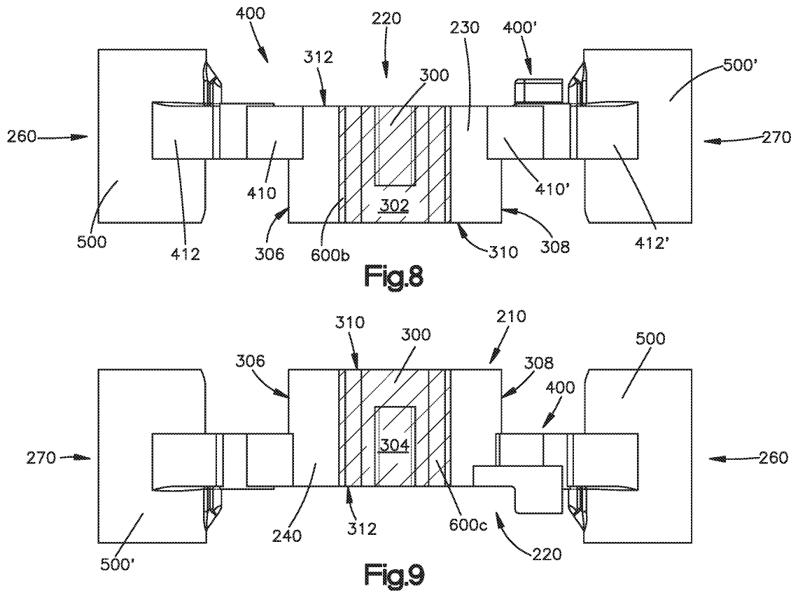

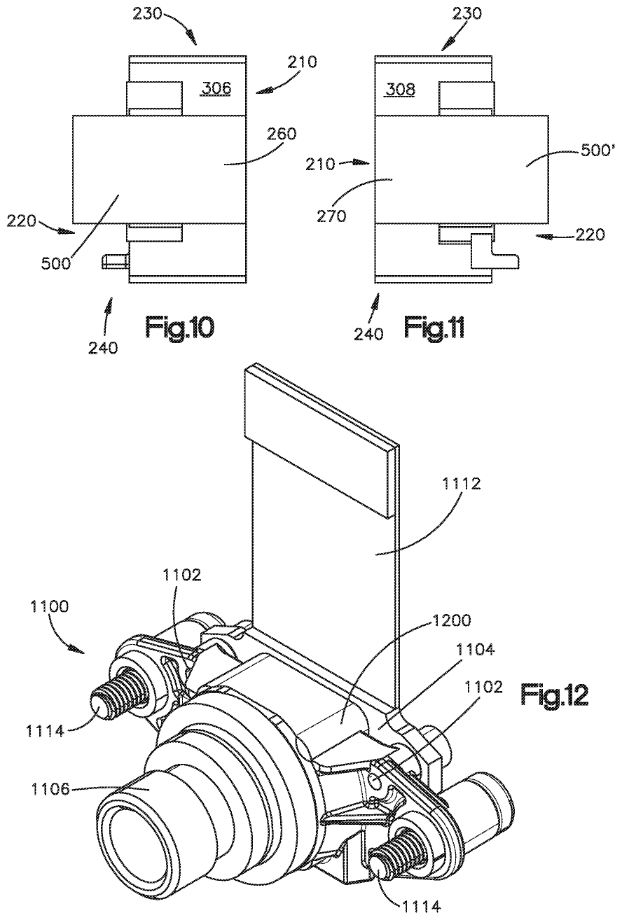

The camera mount 200 is shown in further detail in FIGS. 6-11. The camera mount 200 includes a front side 210 (FIG. 6), a back side 220 (FIG. 7), a top side 230 (FIG. 8), a bottom side 240 (FIG. 9), a right side 260 (FIG. 10), and a left side 270 (FIG. 11). As used in this disclosure, the orientation of the right side 260 and left side 270 is made with respect to the field of view of the camera assembly 100. The camera mount 200 has a length that extends from the right side 260 to the left side 270, a height that extends from the top side 230 to the bottom side 240, and a width that extends from the front side 210 to the back side 220.

The camera mount 200 includes a main body 300. In one example, the main body 300 is substantially cuboid shaped. However, it is contemplated that the main body 300 can be any desired shape. The main body 300 has an upper face 302 and a lower face 304, a left side face 306 and a right side face 308, and a front face 310 and a rear face 312.

The camera lens 106 is received in an opening 314 provided in the main body 300. The opening 314 extends completely through the width of the main body 300. In one example, the opening 314 is substantially cylindrical shaped. However, it is contemplated that the opening 314 can be any desired shape. The rear face 312 of the main body 300 abuts against the printed circuit board 104 when the printed circuit board 104 is attached to the camera mount 200 by the first fasteners 102. With the printed circuit board 104 abutting the rear face 312, the image sensor 110 is received in a depression 316 (FIG. 5) provided on the rear face 312. The depression 316 extends into the rear face 312 and toward the front face 310. In one example, the perimeter of the depression 316 is substantially square so as to mimic the substantially square perimeter of the image sensor 110. However, it is contemplated that the perimeter of the depression 316 and/or the image sensor 110 can be any desired shape.

The camera mount 200 (FIGS. 6-11) further includes a first arm 400. The first arm 400 extends away from the right side face 308 of the main body 300. In one example, the width of the first arm 400 is less than the width of the main body 300 (see FIGS. 8 and 9). However, it is contemplated that the first arm 400 may have any desired width.

The first arm 400 includes a first section 410 and a second section 412. The first section 410 extends directly away from the main body 300 and spaces the second section 412 from the main body 300 along the length of the camera mount 200. In one example, the height of the first section 410 is greater than the height of the second section 412 (see FIGS. 6 and 7). However, it is contemplated that the height of the first section 410 can be less than, or equal to, the height of the second section 412.

Fastener apertures 422 are provided in the first section 410. The fastener apertures 422 extend completely though the width of the first arm 400. The fastener apertures 422 receive the first fasteners 102 that attach the printed circuit board 104 to the camera mount 200.

The camera mount 200 further includes a first attaching section 500. The first attaching section 500 is provided at an end of the first arm 400. The first arm 400 spaces the first attaching section 500 away from the main body 300 along the length of the camera mount 200. In one example, the first attaching section 500 is substantially cylindrical. However, it is contemplated that the first attaching section 500 can be any desired shape. An aperture 504 extends completely through the width of the first attaching section 500. The aperture 504 receives the second fastener 114 that anchors the camera mount 200 in the module 20.

In one example, the width of the first attaching section 500 is greater than the width of the first and second sections 410, 412 of the first arm 400. The height of the first attaching section 500 is equal to the height of the second section 412 of the first arm 400. However, it is contemplated that width of the first attaching section 500 can be less than, or equal to, the width of the first and second sections 410, 412 of the first arm 400. Additionally, it is contemplated that the height of the attaching section 500 can be greater than, or less than, the height of the second section 412 of the arm.

The camera mount 200 further includes a second arm 400′ and a second attaching section 500′. The second arm 400′ extends away from the left side face 306 of the main body 300. The second attaching section 500′ is provided at an end of the second arm 400′. The second arm 400′ spaces the second attaching section 500′ away from the main body 300 along the length of the camera mount 200. The second arm 400′ and the second attaching section 500′ are substantially similar to the first arm 400 and the first attaching section 500, respectively. As such, the specifics of the second arm 400′ and the second attaching section 500′ will not be described further. Features of the second arm 400′ and the second attaching section 500′ that are similar to the features of the first arm 400 and the first attaching section 500, respectively, will be identified with like numerals appended with a prime (′).

High stress concentration areas can be present at various points of the camera mount 200. The high stress concentration areas can be created due to a variety of reasons including, for example, the design of the casting used to manufacture the camera mount 200, the geometry of parts of the camera mount 200, and/or porosity in the camera mount 200 generated during the casting process of the camera mount 200. These areas of high stress concentration can be especially susceptible to corrosion. In order to improve the robustness of the module 50, portions of the camera mount 200 can be burnished to ward off corrosion.

For the purposes of illustration, burnished portions 600a, 600b, 600c of the camera mount 200 are indicated by cross hatching. In one example, a portion 600a of the rear face 312 of the main body 300 surrounding the depression 316 and portions 600b, 600c of the upper and lower faces 302, 304 of the main body 300 are burnished. The portion 600a of the rear face 312 engages the printed circuit board 104 when the camera mount is connected to the printed circuit board. It is contemplated that other burnishing arrangements can be provided. For example, the burnished portions 600a, 600b, 600c of the rear face 312, the upper face 302, and/or the lower face 304 of the main body 300 can be expanded or reduced. As another example, other portions of the main body 300 beyond the aforementioned portions can be burnished. As yet another example, a portion, or portions, of one or more of the first arm 400, the second arm 400′, the first attaching section 500, and the second attaching section 500′ can be burnished.

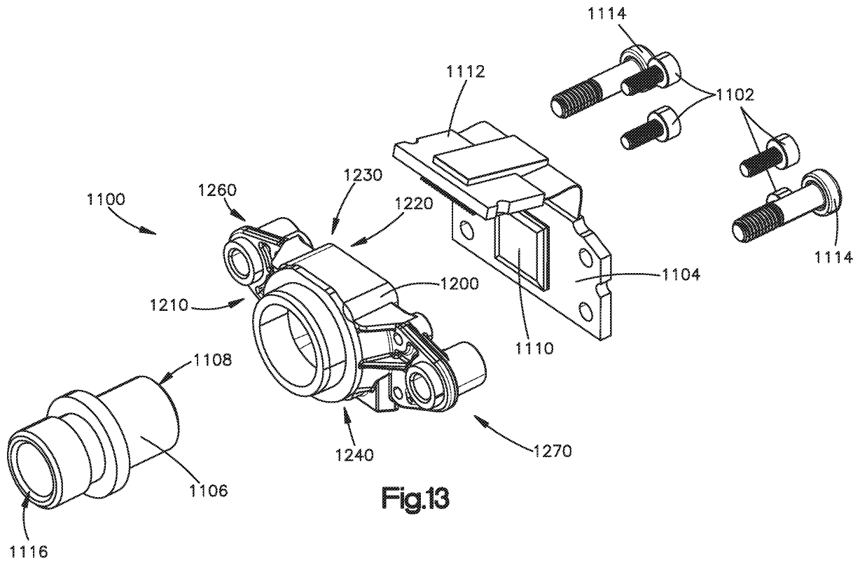

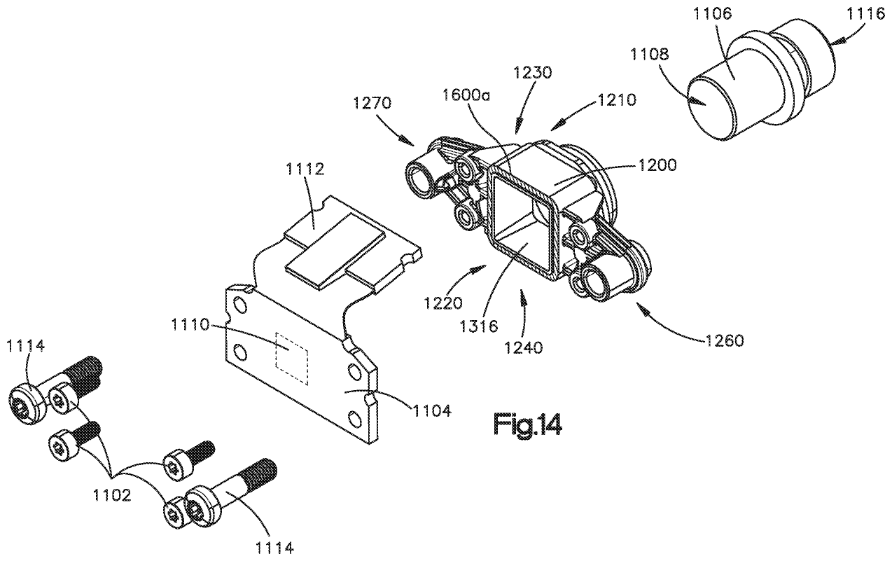

A camera assembly 1100 according to another embodiment of the present invention is shown in FIGS. 12-14. The camera assembly 1100 includes a camera mount 1200 that is secured in a module (not shown). The module can be of the type shown in FIGS. 1 and 2. However, it is contemplated that the camera assembly 1200 can be used with any desired module. First fasteners 1102 attach a printed circuit board 1104 to the camera mount 1200. A camera lens 1106 is received in the camera mount 1200. A first end portion 1108 of the camera lens 1106 is disposed adjacent to an image sensor 1110 provided on the printed circuit board 1104. The image sensor 1110 converts an optical image that is transmitted through the camera lens 1106 into an electrical signal. A flex connector 1112 communicates the electrical signal generated by the image sensor 1110 to main control circuitry (not shown) that analyzes the output of the image sensor 1110.

Second fasteners 1114 anchor the camera assembly 1100 in the module. When the camera assembly 1100 is anchored in the module by the second fasteners 1114, a second end portion 1116 of the camera lens 1106 is disposed in an opening provided on the module. The opening provides the camera assembly 1100 with a field of view outside of the module.

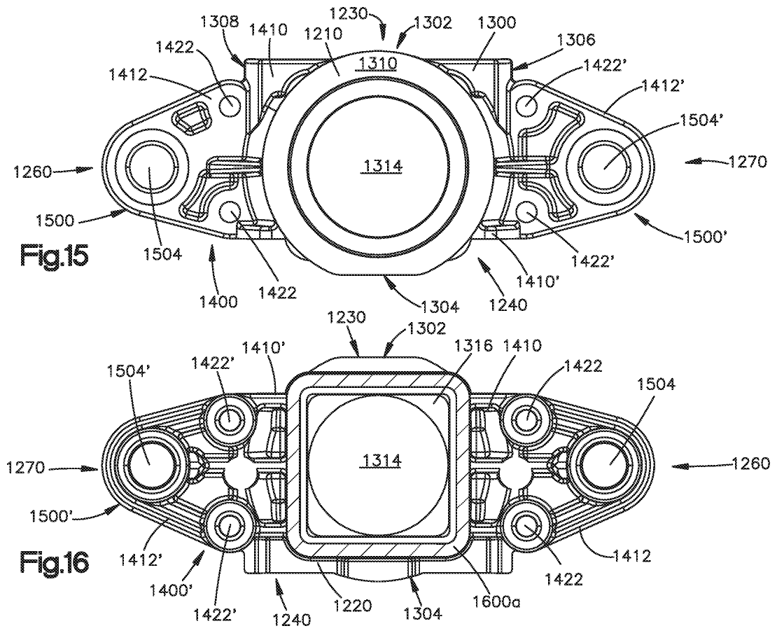

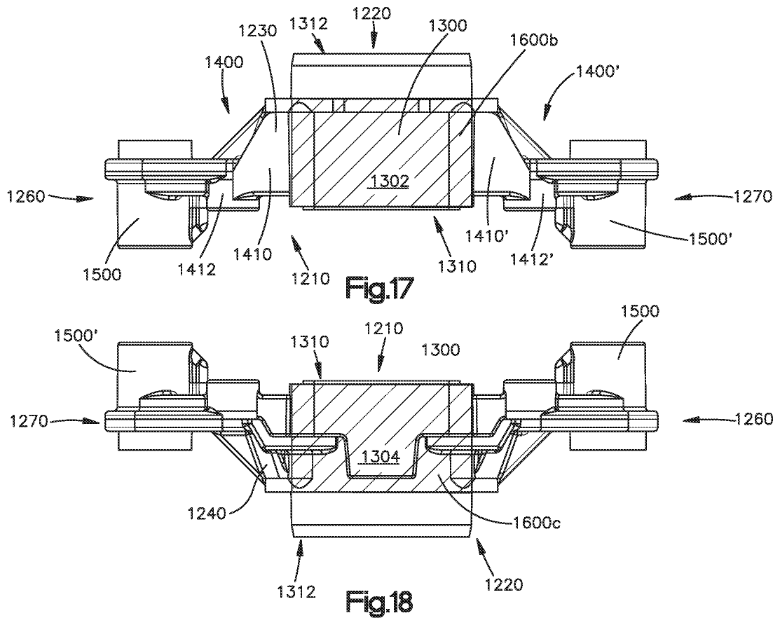

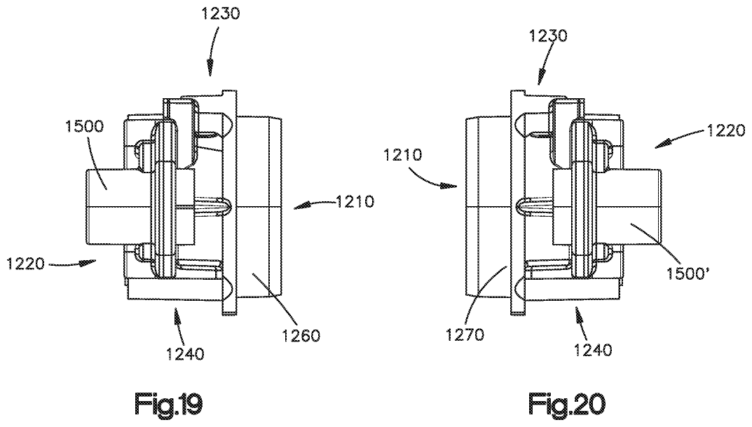

The camera mount 1200 is shown in further detail in FIGS. 15-20. The camera mount 1200 includes a front side 1210 (FIG. 15), a back side 1220 (FIG. 16), a top side 1230 (FIG. 17), a bottom side 1240 (FIG. 18), a right side 1260 (FIG. 19), and a left side 1270 (FIG. 20). As used in this disclosure, the orientation of the right side 1260 and left side 1270 is made with respect to the field of view of the camera assembly 1100. The camera mount 1200 has a height that extends top side 1230 to the bottom side 1240, a length that extends from the right side 1260 to the left side, and a width that extends from the front side 1210 to the back side 1220.

The camera mount includes a main body 1300. In one example, the main body 1300 has a cylindrical section 1301 and a cuboid section 1303 extending axially from the cylindrical section. However, it is contemplated that the main body 1300 can be a combination of any desired shapes or a single shape. The main body 1300 has an upper face 1302 and a lower face 1304, a left side face 1306 and a right side face 1308, and a front face 1310 and a rear face 1312.

The camera lens 1106 is received in an opening 1314 provided in the main body 1300. The opening 1314 extends completely through the entire width of the main body 1300. In one example, the opening 1314 is substantially cylindrical shaped. However, it is contemplated that the opening 1314 can be any desired shape. The rear face 1312 of the main body 1300 abuts against the printed circuit board 1104 when the printed circuit board 1104 is attached to the camera mount 1200 by the second fasteners 1102. With the printed circuit board 1104 abutting the rear face 1312, the image sensor 1110 is received in a depression 1316 provided on the rear face 1312. The depression 1316 extends into the rear face 1312 and toward the front face 1310. In one example, the perimeter of the depression 1316 is substantially square so as to mimic the substantially square perimeter of the image sensor 1100. However, it is contemplated that the perimeter of the depression 1316 and/or the image sensor 1100 can be any desired shape.

The camera mount 1200 further includes a first arm 1400. The first arm 1400 extends away from the right side face 1308 of the main body 1300. In one example, the first arm 1400 is directly attached to only the cuboid section 1303 of the main body 1300 (see FIGS. 17 and 18). However, it is contemplated that the first arm 1400 can be directly attached to only the cylindrical section 1301. Additionally, it is contemplated that the first arm 1400 can be directly attached to both the cylindrical section 1301 and the cuboid section 1303.

The first arm 1400 includes a first section 1410, fastener apertures 1422, and a second section 1412. The first section 1410 extends directly from the main body 1300 and spaces the fastener apertures 1422 from the main body along the length of the camera mount 1200. In one example, the height of the first section 1410 is constant (see FIG. 16), and the width of the first section 1410 is tapered (see FIG. 17). However, it is contemplated that first section 1410 can have any desired configuration.

The second section 1412 is provided at the end of the first arm 1400. In one example, the height of the second section 1412 is tapered (see FIG. 16), and the width of the second section 1412 is constant (see FIG. 17). However, it is contemplated that the second section 1412 can have any desired configuration.

The fastener apertures 1422 are provided in the second section 1412. The fastener apertures 1422 extend completely through the width of the first arm 1400. The fastener apertures 1422 receive the first fasteners 1102 that attach the printed circuit board 1104 to the camera mount 1200.

The camera mount 1200 further includes a first attaching section 1500. The first attaching section 1500 is provided at an end of the second section 1412 of the first arm 1400. The first arm 1400 spaces the first attaching section 1500 away from the main body 1300 along the length of the camera mount 1200. In one example, the first attaching section 1500 is substantially cylindrical. However, it is contemplated that the first attaching section 1500 can be any desired shape. The first attaching section 1500 includes an aperture 1504 that extends completely through the width of the first attaching section 1500. The aperture 1504 receives the second fastener 1114 that anchors the camera mount 1200 in the module.

The camera mount 1200 further includes a second arm 1400′ and a second attaching section 1500′. The second arm 1400′ extends away from the left side face 1306 of the main body 1300. The second arm 1400′ includes a first section 1410′, fastener apertures 1422′, and a second section 1412′. The attaching section 1500′ is provided at an end of the second section 1412′ of the second arm 1400′. The construction of the second arm 1400′ and the second attaching section 1500′ is substantially identical to the first arm 1400 and first attaching section 1500, respectively. As such, the specifics of the second arm 1400′ and the second attaching section 1500′ will not be described further. Features of the second arm 1400′ and the second attaching section 1500′ that are similar to the features of the first arm 1400 and first attaching section 1500 will be identified by like numerals appended with a prime (′).

As discussed above, high stress concentration areas can be present at various areas of the camera mount 1200. To prevent corrosion of the high stress concentration areas, portions 1600a, 1600b, 1600c of the camera mount 1200 can be burnished. In one example, burnished areas 1600 (indicated by cross hatching) are provided at a portion 1600a of the rear face 1312 of the main body 1300 surrounding the depression 1316 and portions 1600b, 1600c of the upper and lower faces 1302, 1304 of the main body 1300. However, it is contemplated that other burnishing arrangements can be provided. For example, the burnished portions 1600a, 1600b, 1600c of the rear end 1312, the upper end 1302, and/or the lower end 1304 of the main body 1300 can be expanded or reduced. As another example, other portions of the main body 1300 beyond the aforementioned surfaces can be burnished. As yet another example, a portion, or portions, of one or more of the first arm and the second arm 1400, 1400′ and the first and second attaching section 1500, 1500′ can be burnished.

The above described burnishing creates a compressive layer on surfaces of the part of the module to which the camera lens is mounted with minimum cold work. The burnishing enhances localized compressive residual stress and improves the corrosion resistance of the camera mount, thereby improving the robustness of the module. What have been described above are examples of the disclosure. It is, of course, not possible to describe every conceivable combination of components or method for purposes of describing the disclosure, but one of ordinary skill in the art will recognize that many further combinations and permutations of the disclosure are possible. For example, although the burnishing of a specific camera mount has been described, it is contemplated that the burnishing process could be applied to camera mounts having configurations that are different from the camera mount described in the present disclosure. Furthermore, it is contemplated that the burnishing process could be applied to modules having configurations that are different from the module described in the present disclosure. Additionally, it is contemplated that other parts of the module could be burnished to further improve robustness of the module. Accordingly, the disclosure is intended to embrace all such alterations, modifications, and variations that fall within the scope of this application, including the appended claims.

1. A driver assist system for a vehicle comprising:
a module; and
a camera assembly connected inside the module, the camera assembly including a burnished camera mount and a camera lens connected to the burnished camera mount having a compressive layer, the camera lens extending into the camera mount.

2. The driver assist system according to claim 1, wherein the burnished camera mount includes opposed upper and lower faces, opposed left and right side faces, and opposed front and rear faces, at least one of the upper face, the lower face, and the rear face being burnished.

3. The driver assist system according to claim 3, wherein the upper face, the lower face, and the rear face are burnished.

4. The driver assist system according to claim 1, wherein the camera assembly includes an image sensor for converting an optical image that is transmitted through the camera lens into an electrical signal, the burnished camera mount including a depression that receives the image sensor, a portion of the camera mount surrounding the depression being burnished.

5. The driver assist system according to claim 1, wherein the camera assembly includes a printed circuit board attached to the camera mount, a face of the camera mount that engages the printed circuit board being burnished.

6. The driver assist system according to claim 1, wherein the camera mount includes a main body having an opening that receives the camera lens and arms extending from the main body, attaching sections at an end of each of the arms receive fasteners that anchor the camera mount in the module, the main body being burnished.

7. The driver assist system according to claim 6, wherein each of the arms includes at least one fastener aperture that receives a fastener for attaching a printed circuit board to the main body.

8. The driver assist system according to claim 7, wherein a face of the main body that abuts the printed circuit board is burnished.

9. The driver assist system according to claim 6, wherein the main body includes a cylindrical section and a cuboid section extending axially from the cylindrical section.

10. The driver assist system according to claim 1, wherein the camera mount is anchored in the module such that an end of the camera lens is disposed in an opening provided on the module to provide the camera assembly with a field of view outside the module.

11. The driver assist system according to claim 4, wherein the camera assembly includes an image sensor provided on a printed circuit board, the image sensor converting an optical image that is transmitted through the camera lens into an electrical signal, the printed circuit board abutting the rear face.
